(19) United States
(12) Patent Application Publication
(10) Pub. No.: US 2024/0429499 A1
(43) Pub. Date: Dec. 26, 2024

(54) SOLID-STATE RECHARGEABLE BATTERY

(71) Applicant: Samsung SDI Co., Ltd., Yongin-si (KR)

(72) Inventors: Ik Hwan CHO, Yongin-si (KR); Changhee WOO, Yongin-si (KR); Jinhwan PARK, Yongin-si (KR); Jiwan YOU, Yongin-si (KR); Isaac SHIN, Yongin-si (KR); Riyul KIM, Yongin-si (KR); Kwang Jong SUH, Yongin-si (KR)

(21) Appl. No.: 18/746,242

(22) Filed: Jun. 18, 2024

(30) Foreign Application Priority Data
Jun. 20, 2023 (KR) 10-2023-0079264

(51) Int. Cl. H01M 50/131; H01M 50/383; H01M 50/474

(52) U.S. Cl. CPC H01M 50/131; H01M 50/383; H01M 50/474

(57) ABSTRACT

A solid-state rechargeable battery comprising a laminate the laminate including a negative electrode, a solid electrolyte layer, and a positive electrode stacked on one another; and an elastic sheet the elastic sheet including a structure of protrusions and depressions stacked on an outermost portion of the laminate including a negative electrode, a solid electrolyte layer, and a positive electrode stacked on one another.

### CROSS-REFERENCE TO RELATED APPLICATION

This application claims priority to and the benefit of Korean Patent Application No. 10-2023-0079264 filed in the Korean Intellectual Property Office on Jun. 20, 2023, the entire contents of which are incorporated herein by reference.

### BACKGROUND

### 1. Field

Embodiments relate to a solid-state rechargeable battery.

### 2. Description of the Related Art

Recently, the development of batteries with high energy density and safety is being actively conducted in response to industry demands. For example, lithium ion batteries are being put to practical use not only in information-related devices and communication devices, but also in the automotive field. In the automotive field, the safety is particularly important because it relates to life.

The above information disclosed in this Background section is only for enhancement of understanding of the background of the invention and therefore it may contain information that does not form the prior art that is already known in this country to a person of ordinary skill in the art.

### SUMMARY

Embodiments are directed to a solid-state rechargeable battery including a laminate including a negative electrode, a solid electrolyte layer, and a positive electrode stacked on one another; and an elastic sheet including a structure of protrusions and depressions stacked on an outermost portion of the laminate and buffering changes of a volume of the laminate during charge and discharge.

The elastic sheet may be stacked on an outer surface of the negative electrode or the positive electrode.

The elastic sheet may include a base portion, protrusions protruding from the base portion, and a groove between adjacent protrusions and in the base portion.

The groove may form a lattice structure on a plane of the base portion.

The lattice structure may be a square or rectangular lattice structure, and each side of respective squares or rectangles of the square or rectangular lattice structure may have a length of about 0.5 mm to about 1.5 mm and may extend in either a first direction or a second direction intersecting with the first direction.

A width of the groove may be about 3 μm to about 20 μm, and a height of the groove may be about 2 μm to about 6 μm.

The groove may have a rectangular structure in a cross-section of the base portion.

The groove may have a trapezoidal structure in a cross-section of the base portion.

The groove may form a stripe structure on a plane of the base portion.

The groove may form a honeycomb structure on a plane of the base portion.

The groove may form a wave structure on a plane of the base portion.

The base portion may include an extinguishing capsule.

Embodiments are directed to a solid-state rechargeable battery including a first unit cell and a second unit cell each unit cell including a negative electrode, a solid electrolyte layer, and a positive electrode stacked on one another; and an elastic sheet with a structure of protrusions and depressions stacked between the first unit cell and the second unit cell and on an outermost portion of the first unit cell or the second unit cell and buffering changes of volumes of the first unit cell and the second unit cell during charge and discharge.

The elastic sheet may include a base portion, protrusions protruding from the base portion, and a groove between adjacent protrusions and in the base portion.

The base portion may contact a negative electrode of the first unit cell, and the protrusions and the groove may contact a positive electrode of the second unit cell.

The elastic sheet on the outermost portion of the first unit cell or the second unit cell may include an extinguishing capsule in the base portion.

### BRIEF DESCRIPTION OF THE DRAWINGS

Features will become apparent to those of skill in the art by describing in detail exemplary embodiments with reference to the attached drawings in which:

FIG. 1 shows a cross-sectional view of a solid-state rechargeable battery according to an embodiment.

FIG. 2 shows a cross-sectional view of formation of a lithium metal layer of a solid-state rechargeable battery according to an embodiment.

FIG. 3A shows a cross-sectional view before pressurizing a solid-state rechargeable battery according to a first embodiment of the present disclosure.

FIG. 3B shows a cross-sectional view after pressurizing a solid-state rechargeable battery according to a first embodiment of the present disclosure.

FIG. 4 shows a bottom view of an elastic sheet applied to FIG. 3A and FIG. 3B.

FIG. 5 shows an enlarged cross-sectional view of a portion of an elastic sheet applied to a first embodiment of the present disclosure.

FIG. 6 shows an enlarged cross-sectional view of a portion of an elastic sheet applied to a solid-state rechargeable battery according to a second embodiment of the present disclosure.

FIG. 7 shows a bottom view of an elastic sheet applied to a solid-state rechargeable battery according to a third embodiment of the present disclosure.

FIG. 8 shows a bottom view of an elastic sheet applied to a solid-state rechargeable battery according to a fourth embodiment of the present disclosure.

FIG. 9 shows a bottom view of an elastic sheet applied to a solid-state rechargeable battery according to a fifth embodiment of the present disclosure.

FIG. 10 shows a bottom view of a portion of an elastic sheet applied to a solid-state rechargeable battery according to a sixth embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

It will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Unless explicitly described to the contrary, the word “comprise”, and variations such as “comprises” or “comprising”, will be understood to imply the inclusion of stated elements but not the exclusion of any other elements.

In the drawings, the thickness of layers, films, panels, regions, etc., are enlarged for clarity, and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface. Herein, “or” is not an exclusive term, for example, “A or B” may mean A, B, or A and B.

Positive electrode for solid-state rechargeable battery

One embodiment may provide a positive electrode for a solid-state rechargeable battery including a current collector and a positive active material layer on the current collector, wherein the positive active material layer may include a positive active material, a sulfide solid electrolyte, a fluorinated resin binder, and a vanadium oxide.

The positive electrode for a solid-state rechargeable battery may be manufactured by applying a positive electrode composition containing a positive active material, a sulfide solid electrolyte, a fluorinated resin binder, and a vanadium oxide to a current collector, drying them, and rolling them.

The positive electrode composition may have a strong basicity due to residual lithium such as LiOH or other components, which may result in gelation or agglomeration of the fluorinated resin binder. In an implementation, by adding a vanadium oxide, gelation of the fluorinated resin binder may be suppressed and processability may be secured by maintaining the viscosity of the positive electrode composition. There may be no need to use a neutralizing agent so degradation of the sulfide solid electrolytes by the neutralizing agent may be prevented, thereby improving performance of the solid-state rechargeable battery.

### Vanadium Oxide

The vanadium oxide may be a solvent-insoluble component of the positive electrode composition, controlling the strong basicity of the positive electrode composition to prevent gelation of the fluorinated resin binder, while simultaneously suppressing the degradation of the sulfide solid electrolyte, and thereby improving the ion conductivity of the positive electrode. The vanadium oxide may control pH through physical or chemical reactions with —OH groups in the positive electrode composition in the strong base state and thus suppresses gelation of the fluorinated resin binder. Compared to other transition metal oxides such as a titanium oxide or a tungsten oxide, the vanadium oxide may have a more excellent ability to control basicity and suppress gelation of the fluorinated resin binder and may have low reactivity to the sulfide solid electrolytes, and the ion conductivity of the solid-state rechargeable batteries may be improved and the overall performance may be improved by suppressing the degradation of the sulfide solid electrolytes.

The vanadium oxide may include, e.g., V₂O₃, VO₂, V₂O₄, V₂O₅, or combinations thereof. The vanadium oxide may be included in an amount of about 0.01 wt % to about 5 wt %, based on a total weight of the positive active material layer, e.g., about 0.05 wt % to about 5 wt %, about 0.1 wt % to about 5 wt %, about 0.5 wt % to about 5 wt %, or about 0.5 wt % to about 3 wt %. Maintaining the vanadium oxide in the above ranges may help ensure the viscosity of the positive electrode composition may be appropriately maintained without deterioration of capacity, thereby improving processability and improving the ion conductivity of the positive electrode.

In an implementation, the positive electrode composition may be coated on the current collector in a state in which the vanadium oxide may be dispersed by adding the vanadium oxide to the positive electrode composition, so the vanadium oxide may be dispersed in the manufactured positive active material layer. This is different from the form in which vanadium oxide may be coated on the surface of the positive active material or the sulfide solid electrolyte.

In an implementation, the vanadium oxide may be a pentavalent vanadium (V) oxide, in which case a melting point of the vanadium oxide may be equal to or less than about 1,000° C., e.g. about 600° C. to about 800° C., or about 650° C. to about 690° C. The pentavalent vanadium oxide may be excellent at suppressing the gelation of the fluorinated resin binder in the positive electrode and may be advantageous for improving overall performance of the battery.

The vanadium oxide may be in a particle form and its average particle diameter D50 may be about 10 nm to about 10 μm, e.g., about 10 nm to 5 μm, about 10 nm to 3 μm, about 50 nm to 1 μm, about 50 nm to about 500 nm, or about 500 nm to 1 μm. The vanadium oxide with these physical properties may be suitable for being input to the positive electrode composition, and may effectively suppress gelation of the positive electrode composition without adversely affecting the positive electrode. If a particle diameter of the vanadium oxide is too small, it may not be dispersed properly in the positive electrode, blocking a passage of electrons and ions, which may deteriorate battery performance, or may not sufficiently play the role of suppressing gelation of the binder. If the particle diameter of the vanadium oxide is too large, it may block the passage of electrons and ions, thereby deteriorating the performance of the battery.

### Fluorinated Resin Binder

In an implementation, the fluorinated resin binder may be a resin binder including fluorine, e.g., it may include polyvinylidene fluoride, polyvinylidene fluoride-hexafluoropropylene copolymer, polyvinylidene fluoride-trichloroethylene copolymer, polyvinylidene fluoride-chlorotrifluoroethylene copolymer, polytetrafluoroethylene, or combinations thereof.

A weight average molecular weight of the fluorinated resin binder may be about 50 kDa to about 5,000 kDa, or about 100 kDa to about 2,000 kDa. A glass transition temperature of the fluorinated resin binder may be, e.g., equal to or less than about −10° C., and a melting point may be equal to or greater than about 100° C. A melting viscosity of the fluorinated resin binder may be about 10 kP to about 50 kP. The fluorinated resin binder may include particles and a mean particle diameter may be about 50 nm to about 200 μm. The fluorinated resin binder having the above physical properties may have excellent adherence if a small amount thereof is put into the positive electrode composition, and it may help increase durability of the battery without negatively influencing the battery performance.

The fluorinated resin binder may be included in an amount of about 0.1 wt % to about 10 wt % based on a total weight of the positive active material layer, e.g., in the amount of about 0.1 wt % to about 8 wt %, about 0.1 wt % to about 6 wt %, about 0.1 wt % to about 5 wt %, about 0.5 wt % to about 4 wt %, or about 1 wt % to about 3 wt %. Maintaining the fluorinated resin binder within the above content range may help it have excellent adherence without negatively influencing the positive electrode.

### Positive Active Material

The positive active material may be a positive active material suitable for use in a solid-state rechargeable battery. In an implementation, the positive active material may be a compound allowing reversible intercalation and deintercalation of lithium, and may include a compound expressed as one of following formulae. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}D_{α} (0.90≤a≤1.8, 0≤b≤0.5, 0≤c≤0.5, 0≤α≤2); LiₐNi_{1-b-c}Co_{b}X_{c}O_{2-α}T_{α} (0.90≤a≤1.8, 0≤b≤0.5, 0≤c≤0.05, 0<α≤2); LiₐNi_{1-b-c}Co_{b}X_{c}O_{2-α}T₂ (0.90≤a≤1.8, 0≤b≤0.5, 0≤c≤0.05, 0<α≤2); LiₐNi_{1-b-c}Mn_{b}X_{c}D_{α} (0.90≤a≤1.8, 0≤b≤0.5, 0≤c≤0.05, 0<α≤2); LiₐNi_{1-b-c}Mn_{b}X_{c}O_{2-α}T_{α} (0.90≤a≤1.8, 0≤b≤0.5, 0≤c≤0.05, 0<α<2); LiₐNi_{1-b-c}Mn_{b}X_{c}O_{2-α}T₂(0.90≤a≤1.8, 0≤b≤0.5, 0≤c≤0.05, 0<α<2); LiₐNi_{b}E_{c}G_{d}O₂(0.90≤a≤1.8, 0≤b≤0.9, 0≤c≤0.5, 0.001≤d≤0.1); LiₐNi_{b}Co_{c}Mn_{d}GeO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}GbO₂ (0.90≤a≤1.8, 0.001≤b≤0.1); LiₐMn₂GbO₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂ PO₄₃ (0≤f≤2); Li_{(3-f)}Fe₂ PO₄₃ (0≤f≤2); LiₐFePO₄ (0.90≤a≤1.8).

Regarding the above formulae, A may be Ni, Co, Mn, or combinations thereof, X may be Al, Ni, Co, Mn, Cr, Fe, Mg, Sr, V, rare earth elements, or combinations thereof, D may be O, F, S, P, or combinations thereof, E may be Co, Mn, or combinations thereof, T may be F, S, P, or combinations thereof, G may be Al, Cr, Mn, Fe, Mg, La, Ce, Sr, V, or combinations thereof, Q may be Ti, Mo, Mn, or combinations thereof, Z may be Cr, V, Fe, Sc, Y, or combinations thereof, and J may be V, Cr, Mn, Co, Ni, Cu, or combinations thereof.

In an implementation, the positive active material may be, e.g., a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or a lithium iron phosphate oxide (LFP).

In an implementation, positive active material may include a lithium nickel oxide expressed in Formula 1, a lithium cobalt oxide expressed in Formula 2, a lithium iron phosphate compound expressed in Formula 3, or combinations thereof.

Liₐ₁Niₓ₁M¹_{y1}M²_{1-x1-y1}O₂ [Chemical Formula 1]

In Chemical Formula 1, 0.9≤a1≤1.8, 0.3≤x1≤1, 0≤y1≤0.7, and M¹ and M² may each independently be Al, B, Ba, Ca, Ce, Co, Cr, Cu, F, Fe, Mg, Mn, Mo, Nb, P, S, Si, Sr, Ti, V, W, or Zr.

Liₐ₂Coₓ₂M³₁₋ₓ₂O₂ [Chemical Formula 2]

In Chemical Formula 2, 0.9≤a2≤1.8, 0.6≤x2≤1, and M³ may be Al, B, Ba, Ca, Ce, Cr, Cu, F, Fe, Mg, Mn, Mo, Nb, P, S, Si, Sr, Ti, V, W, or Zr.

Liₐ₃Feₓ₃M⁴₁₋ₓ₃PO₄ [Chemical Formula 3]

In Chemical Formula 3, 0.9≤a3≤1.8, 0.6≤x3≤1, and M⁴ may be Al, B, Ba, Ca, Ce, Co, Cr, Cu, F, Fe, Mg, Mn, Mo, Nb, P, S, Si, Sr, Ti, V, W, or Zr.

The average particle diameter D50 of the positive active material may be about 1 μm to about 25 μm, e.g., about 3 μm to about 25 μm, about 5 μm to about 25 μm, about 5 μm to about 20 μm, about 8 μm to about 20 μm, or about 10 μm to about 18 μm. The positive active material having the particle diameter range may be mixed with other components in the positive active material layer and may realize high capacity and high energy density.

The positive active material may have a secondary particle form made by agglomerating primary particles or may have a single particle form. The positive active material may have a spherical shape or another shape that is similar to the spherical shape, or may be a polyhedron or atypical.

### Sulfide Solid Electrolyte

The sulfide solid electrolyte may include, e.g., Li₂S—P₂S₅, Li₂S—P₂S₅—LiX (X may be a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are integers, and Z may be, e.g., Ge, Zn, or Ga), Li₂S—GeS₂, Li₂S—SiS₂—Li₃PO₄, Li₂S—SiS₂-LiₚMO_{q} (p and q are integers, and M may be, e.g., P, Si, Ge, B, Al, Ga, or In), or combinations thereof.

The sulfide solid electrolyte may be obtained by, e.g., mixing Li₂S and P₂S₅ in a mole ratio of about 50:50 to about 90:10 or in a mole ratio of about 50:50 to about 80:20 and selectively performing a heat treatment. Maintaining the mixing ratio in the above ranges may help ensure that a sulfide solid electrolyte with excellent ion conductivity may be prepared. The ion conductivity may be further increased by including other components, e.g., SiS₂, GeS₂, or B₂S₃.

A mechanical milling or a solution method may be applied as a method for mixing sulfur-containing materials and producing a sulfide solid electrolyte. The mechanical milling may be a method for inserting start materials and a ball mill into a reactor and strongly agitating them to particulate the start materials and mix them. In an implementation, the solution method may be used, and the solid electrolyte may be obtained as a precipitate by mixing the starting materials in a solvent. In an implementation, heat treatment may be performed after mixing and may help the solid electrolyte crystals become more solid and the ion conductivity may be improved. In an implementation, the sulfide solid electrolyte may be prepared by mixing sulfur-containing materials and heat treating them at least twice, and in this case, the sulfide solid electrolyte with high ion conductivity and robustness may be prepared.

In an implementation, the sulfide solid electrolyte particle may include an argyrodite-type sulfide. In an implementation, the argyrodite-type sulfide may be expressed by, e.g., the formula of LiₐM_{b}P_{c}S_{d}Aₑ (a, b, c, d and e are each equal to or greater than 0 and equal to or less than 12, M may be, e.g., Ge, Sₙ, Si, or combinations thereof, and A may be, e.g., F, Cl, Br, or I), and may be expressed by the formula of Li₇₋ₓPS₆₋ₓAₓ (x is equal to or greater than 0.2 and equal to or less than 1.8, and A may be F, Cl, Br, or I). The argyrodite-type sulfide may be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, etc.

The sulfide solid electrolyte particles including the argyrodite-type sulfide may have high ion conductivity that is close to the range of about 10⁻⁴ to about 10⁻² S/cm, which may be the ion conductivity of the general liquid electrolytes at ambient temperature, and may form an intimate bond between the positive active material and the solid electrolyte without causing a decrease in the ion conductivity, and may furthermore form an intimate interface between an electrode layer and a solid electrolyte layer. The all-solid-state battery including the same may have improved battery performance, e.g., rate capability, coulombic efficiency, and cycle-life characteristics.

The argyrodite-type sulfide solid electrolyte may be prepared, e.g., by mixing lithium sulfide and phosphorus sulfide, and optionally lithium halide. Heat treatment may be performed after mixing them and may include, e.g., at least two heat treatments.

The average particle diameter D50 of the sulfide solid electrolyte particle according to an embodiment may be equal to or less than about 5.0 μm, e.g., about 0.1 μm to about 5.0 μm, about 0.1 μm to about 4.0 μm, about 0.1 μm to about 3.0 μm, about 0.5 μm to about 2.0 μm, or about 0.1 μm to about 1.5 μm. The sulfide solid electrolyte particles may be small particles with the average particle diameter D50 of about 0.1 μm to about 1.0 μm or large particles with the average particle diameter D50 of about 1.5 μm to about 5.0 μm depending on used positions or purposes. The sulfide solid electrolyte particles in theses particle size ranges may effectively penetrate among the solid particles in the battery, and may have excellent contact with the electrode active material and connectivity among the solid electrolyte particles. The average particle diameter of the sulfide solid electrolyte particles may be measured using a microscope image, an, e.g., a particle size distribution may be obtained by measuring the size of about twenty particles in a scanning electron microscope image, and the diameter D50 may be calculated therefrom.

A content of the solid electrolyte in the positive electrode for a solid-state battery may be about 0.5 wt % to about 35 wt %, e.g., about 1 wt % to about 35 wt %, about 5 wt % to about 30 wt %, about 8 wt % to about 25 wt %, or about 10 wt % to about 20 wt %, based on a total weight of the components in the positive electrode, or, in an implementation, based on the total weight of the positive active material layer.

In an embodiment, the positive active material layer may include, e.g., about 50 wt % to about 99.35 wt % of the positive active material, about 0.5 wt % to about 35 wt % of the sulfide solid electrolyte, about 0.1 wt % to about 10 wt % of the fluorinated resin binder, and about 0.05 wt % to about 5 wt % of the vanadium oxide based on a total weight of the positive active material layer. Maintaining the above-noted content ranges may help ensure that the positive electrode for a solid-state rechargeable battery may realize high capacity and high ion conductivity, may maintain high adherence, and may maintain the viscosity of the positive electrode composition at an appropriate level, thereby improving processability.

### Conductive Material

The positive active material layer may further include a conductive material. The conductive material may help provide conductivity to the electrode, e.g., it may include carbon materials such as natural graphite, artificial graphite, carbon black, acetylene black, Ketjen black, carbon fibers, carbon nanotubes, etc.; metal materials containing copper, nickel, aluminum, and silver and having a metal powder form or a metal fiber form; conductive polymers such as polyphenylene derivatives; or combinations thereof.

The conductive material may be included in an amount of, e.g., about 0.1 wt % to about 5 wt %, or about 0.1 wt % to about 3 wt % based on the total weight of the respective components of the positive electrode for a solid-state battery or, in an implementation, the total weight of the positive active material layer. Maintaining the conductive material within the above content ranges may help ensure that the conductive material may not deteriorate the battery performance but may improve the electrical conductivity.

In an implementation, the positive active material layer may further include a conductive material and the positive active material layer may include about 45 wt % to about 99.25 wt % of the positive active material, about 0.5 wt % to about 35 wt % of the sulfide solid electrolyte, about 0.1 wt % to about 10 wt % of the fluorinated resin binder, about 0.05 wt % to about 5 wt % of the vanadium oxide, and about 0.1 wt % to about 5 wt % of the conductive material, based on a total weight of the positive active material layer.

The positive electrode for a lithium rechargeable battery may further include an oxide inorganic solid electrolyte in addition to the above-described solid electrolyte. The oxide inorganic solid electrolyte may include, e.g., Li₁₊ₓTi₂₋ₓAl PO₄₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y} PO₄₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, garnet ceramics Li₃₊ₓLa₃M₂O₁₂ (M=Te, Nb, or Zr; and x is an integer of 1 to 10), or combinations thereof.

### Solid-State Rechargeable Battery

In an implementation, the solid-state rechargeable battery may include the above-described positive electrode and the negative electrode and the solid electrolyte layer between the positive electrode and the negative electrode. The solid-state rechargeable battery may be referred to as a solid-state battery, or a solid lithium rechargeable battery.

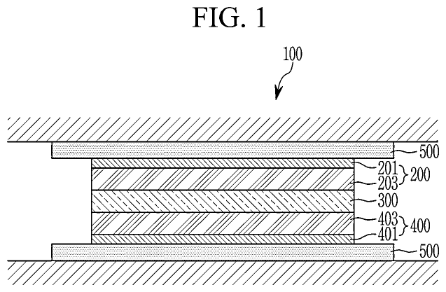

FIG. 1 shows a cross-sectional view of a solid-state rechargeable battery according to an embodiment. Referring to FIG. 1, the solid-state rechargeable battery 100 may have a structure in which an electrode assembly in which a negative electrode 400 including a negative electrode current collector 401 and a negative active material layer 403, a solid electrolyte layer 300, and a positive electrode 200 including a positive active material layer 203 and a positive electrode current collector 201 are stacked in a case such as a pouch. The solid-state rechargeable battery 100 may further include an elastic layer 500 on at least one external side of the positive electrode 200 and the negative electrode 400. As illustrated in FIG. 1, one electrode assembly may include the negative electrode 400, the solid electrolyte layer 300, and the positive electrode 200, and the solid-state battery may be manufactured by stacking at least two electrode assemblies.

### Negative Electrode

The negative electrode for a solid-state battery may include a current collector and a negative active material layer on the current collector. The negative active material layer may include a negative active material, and may further include a binder, a conductive material, or a solid electrolyte.

The negative active material may include a material for reversibly intercalating/deintercalating lithium ions, a lithium metal, alloys of the lithium metal, a material doped to the lithium and dedoped from the same, or a transition metal oxide.

The material for reversibly intercalating/deintercalating lithium ions may include, e.g. crystalline carbon, amorphous carbon, or a combination thereof as a carbon negative active material. The crystalline carbon may be non-shaped, or sheet, flake, spherical, or fiber shaped natural graphite or artificial graphite, and the amorphous carbon may be a soft carbon, a hard carbon, a mesophase pitch carbonized product, calcined coke, and the like.

The alloy of the lithium metal may use an alloy of lithium and at least one metal, e.g., Na, K, Rb, Cs, Fr, Be, Mg, Ca, Sr, Si, Sb, Pb, In, Zn, Ba, Ra, Ge, Al, or Sₙ.

The material capable of doping/dedoping lithium may be a Si negative electrode active material or a Sₙ negative electrode active material. The Si negative electrode active material may include silicon, a silicon-carbon composite, SiOₓ (0<x<2), a Si-Q alloy (wherein Q may be, e.g., an alkali metal, an alkaline-earth metal, a Group 13 element, a Group 14 element, a Group 15 element, a Group 16 element, a transition metal, a rare earth element, and a combination thereof, but not Si) and the Sₙ negative electrode active material may include Sₙ, SnO₂, Sₙ—R alloy (wherein R may be, e.g., an alkali metal, an alkaline-earth metal, a Group 13 element, a Group 14 element, a Group 15 element, a Group 16 element, a transition metal, a rare earth element, or a combination thereof, but not Sₙ), and at least one of these materials may be mixed with SiO₂. The elements Q and R may be, e.g., Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sₙ, In, Tl, Ge, P, As, Sb, Bi, S, Se, Te, Po, or combinations thereof.

The silicon-carbon composite may be, e.g., a silicon-carbon composite including a core including crystalline carbon and silicon particles and an amorphous carbon coating layer on the surface of the core. The crystalline carbon may be artificial graphite, natural graphite, or combinations thereof. The amorphous carbon precursor may be a coal pitch, mesophase pitch, petroleum pitch, coal oil, petroleum heavy oil, or a polymer resin such as a phenol resin, a furan resin, or a polyimide resin. The content of silicon may be, e.g., about 10 wt % to about 50 wt % based on a total weight of the silicon-carbon composite. The content of the crystalline carbon may be, e.g., about 10 wt % to about 70 wt % based on the total weight of the silicon-carbon composite, and the content of the amorphous carbon may be, e.g., about 20 wt % to about 40 wt % based on the total weight of the silicon-carbon composite. A thickness of the amorphous carbon coating layer may be about 5 nm to about 100 nm.

The average particle diameter D50 of the silicon particle may be about 10 nm to about 20 μm, e.g., about 10 nm to about 500 nm. The silicon particles may exist in an oxidized form, and an atomic content ratio of Si:O in the silicon particles indicating a degree of oxidation may be, e.g., about 99:1 to about 33:66. The silicon particle may be particles of SiOₓ, and the range of x in SiOₓ in this case may be greater than 0 and less than about 2. The average particle diameter D50 may be measured using a particle size analyzer using a laser diffraction method and may represent a diameter of the particles whose cumulative volume is 50 volume % in a particle size distribution

The Si negative active material or the Sₙ negative active material may be mixed with the carbon negative active material. A mixing ratio of the carbon negative active material with one of the Si negative active material and the Sₙ negative active material may be, e.g., about 1:99 to about 90:10 as the weight ratio.

The negative active material may be included in an amount of about 95 wt % to about 99 wt %, based on a total weight of the negative active material layer.

In an implementation, the negative active material layer may further include a binder, and may optionally further include a conductive material. The content of the binder on the negative active material layer may be, e.g., about 1 wt % to about 5 wt % based on the entire weight of the negative active material layer. In an implementation further including a conductive material the negative active material layer may include about 90 wt % to about 98 wt % of the negative active material, about 1 wt % to about 5 wt % of the binder, and about 1 wt % to about 5 wt % of the conductive material.

The binder may help well adhere the negative active material particles to each other and may also adhere the negative active material to the current collector. The binder may include a non-water-soluble binder, a water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or combinations thereof.

The water-soluble binder may include a rubber binder or a polymer resin binder. The rubber binder may be, e.g., a styrene-butadiene rubber, an acrylated styrene-butadiene rubber, an acrylonitrile-butadiene rubber, an acrylic rubber, a butyl rubber, a fluororubber, or combinations thereof. The polymer resin binder may be, e.g., a polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, or combinations thereof.

In an implementation using the water-soluble binder as the negative electrode binder, a thickener for providing viscosity may be used together, and the thickener may include, e.g., a cellulose compound. The cellulose compound may include, e.g., carboxymethyl cellulose, hydroxypropyl methyl cellulose, methyl cellulose, alkali metal salts thereof, or combinations thereof. In an implementation, Na, K, or Li may be used as the alkali metal. The used amount of the thickener may be about 0.1 parts by weight to about 3 parts by weight, based on the total weight of the negative active material.

The conductive material may be used to help provide conductivity to the electrode, and may, e.g., include carbon materials such as natural graphite, artificial graphite, carbon black, acetylene black, ketjen black, carbon fibers, or carbon nanotubes; metal materials including copper, nickel, aluminum, or silver and having a metal powder shape or a metal fiber shape; conductive polymers such as a polyphenylene derivative; or mixtures thereof.

The negative current collector may include, e.g., a copper foil, a nickel foil, a stainless steel foil, a titanium foil, a nickel foam, a copper foam, a polymer substrate coated with a conductive metal, and combinations thereof.

In an implementation, the negative electrode for a solid-state battery may be a precipitation-type negative electrode. The precipitation-type negative electrode may be a negative electrode which has no negative active material during the assembly of a battery but in which a lithium metal and the like are precipitated during the charge of the battery and serve as a negative active material.

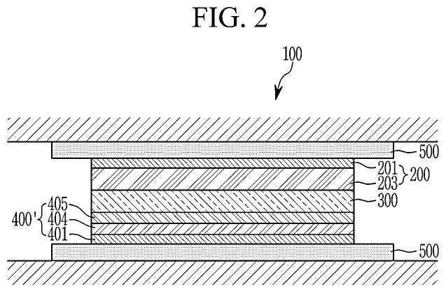

FIG. 2 shows a cross-sectional view on a solid-state rechargeable battery including a precipitation-type negative electrode according to an embodiment. Referring to FIG. 2, the precipitation-type negative electrode 400′ may include a current collector 401 and a negative electrode coating layer 405 on the current collector 401. The solid-state battery having the precipitation-type negative electrode 400′ may start to be initially charged in absence of a negative active material, and a lithium metal with high density and the like may be precipitated between the current collector 401 and the negative electrode coating layer 405 during the initial charge and may form a lithium metal layer 404 which may work as the negative active material. Accordingly, the precipitation-type negative electrode 400′ in the solid-state battery which is charged at least once may include the current collector 401, the lithium metal layer 404 on the current collector, and the negative electrode coating layer 405 on the metal layer 404. The lithium metal layer 404 may represent a layer in which the lithium metal and the like are precipitated during the charge of the battery, and may be referred to as a metal layer or a negative active material layer.

The negative electrode coating layer 405 may include a metal, a carbon material, or a combination thereof functioning as a catalyst. The metal may include, e.g., gold, platinum, palladium, silicon silver, aluminum, bismuth, tin, zinc, or a combination thereof and may be composed of an alloy. In an implementation, a metal may be present in a particle form, an average particle diameter (D50) thereof may be less than or equal to about 4 μm, e.g., about 10 nm to about 4 μm.

The carbon material may be, e.g., crystalline carbon, amorphous carbon, or combinations thereof. The crystalline carbon may be, e.g., natural graphite, artificial graphite, mesophase carbon microbeads, or combinations thereof. The amorphous carbon may be, e.g., carbon black, activated carbon, acetylene black, denka black, ketjen black, or combinations thereof.

In an implementation, the negative electrode coating layer 405 may include the metal and the carbon material and the metal and the carbon material may be, e.g., mixed in the weight ratio of about 1:10 to about 2:1. Maintaining the ratio in the above ranges may help ensure that the precipitation of the lithium metal may be effectively performed and characteristics of the solid-state battery may be improved. The negative electrode coating layer 405 may include, e.g., a carbon material on which a catalyst metal may be supported or may include a mixture of metal particles and carbon material particles.

The negative electrode coating layer 405 may include, e.g., the metal and amorphous carbon, and the precipitation of the lithium metal may be effectively performed.

The negative electrode coating layer 405 may further include a binder, and the binder may be a conductive binder. The negative electrode coating layer 405 may further include general additives, e.g., a filler, a dispersant, and an ion conductive material.

The thickness of the negative electrode coating layer 405 may be, e.g., about 100 nm to about 20 μm, about 500 nm to about 10 μm, or about 1 μm to about 5 μm.

The precipitation-type negative electrode 400′ may further include, e.g., a thin film on a surface of the current collector, e.g., between the current collector and the negative electrode coating layer. The thin film may include an element for forming an alloy with lithium. The element for forming an alloy with lithium may be, e.g., gold, silver, zinc, tin, indium, silicon, aluminum, bismuth, or the like, and may be configured with one of them or may be configured with many types of alloys. The thin film may further planarize the precipitation shape of the lithium metal layer 404 and may further improve the characteristics of the solid-state battery. The thin film may be formed by, e.g., a vacuum deposition method, a sputtering method, a plating method, etc. The thickness of the thin film may, e.g., be about 1 nm to about 500 nm.

### Solid Electrolyte Layer

The solid electrolyte layer 300 may include a sulfide solid electrolyte and an oxide solid electrolyte. Details of the sulfide solid electrolyte and the oxide solid electrolyte have already been described.

In an implementation, the solid electrolyte included in the positive electrode 200 and the solid electrolyte included in the solid electrolyte layer 300 may include the same compound or different compounds. In an implementation, the positive electrode 200 and the solid electrolyte layer 300 may include an argyrodite-type sulfide solid electrolyte and overall performance of the solid-state rechargeable battery may be improved thereby. In an implementation, the positive electrode 200 and the solid electrolyte layer 300 may include the aforementioned coated solid electrolyte and the solid-state rechargeable battery may thereby implement excellent initial efficiency and lifespan characteristics while implementing high capacity and high energy density.

The average particle diameter (D50) of the solid electrolyte included in the positive electrode 200 may be less than the average particle diameter (D50) of the solid electrolyte included in the solid electrolyte layer 300. In this case, overall performance may be improved by increasing the mobility of lithium ions while maximizing the energy density of the solid-state battery. In an implementation, the average particle diameter (D50) of the solid electrolyte included in the positive electrode 200 may be, e.g., about 0.1 μm to about 1.0 μm or about 0.1 μm to about 0.8 μm, and the average particle diameter (D50) of the solid electrolyte included in the solid electrolyte layer 300 may be, e.g., about 1.5 μm to about 5.0 μm, about 2.0 μm to about 4.0 μm, or about 2.5 μm to about 3.5 μm. Maintaining the particle size in the above ranges may help ensure that the energy density of the solid-state rechargeable battery may be maximized while the transfer of lithium ions is facilitated, so that resistance may be suppressed, and thus the overall performance of the solid-state rechargeable battery may be improved. The average particle diameter D50 of the solid electrolyte may be measured through a particle size analyzer using a laser diffraction method. Alternatively, about twenty particles may be arbitrarily selected from a micrograph of a scanning electron microscope or the like, the particle size may be measured, a particle size distribution may be obtained, and the D50 value may be calculated.

The solid electrolyte layer may further include a binder in addition to the solid electrolyte. The binder may include, e.g., a styrene butadiene rubber, polytetrafluoroethylene, polyvinylidene fluoride, polyethylene, an acrylate polymer, or combinations thereof. The acrylate polymer may be, e.g., butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be, e.g., isobutyl isobutyrate, xylene, toluene, benzene, hexane, or a combination thereof.

The thickness of the solid electrolyte layer may be, e.g., about 10 μm to about 150 μm.

The solid electrolyte layer may further include an alkali metal salt or an ionic liquid or a conductive polymer. The alkali metal salt may be, e.g., lithium salt. The concentration of the lithium salt in the solid electrolyte layer may be greater than or equal to about 1 M, e.g., about 1M to about 4M. The lithium salt may help improve ion conductivity by improving lithium ion mobility of the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato)borate (LiDFOB), lithium bis(trifluoro methanesulfonyl)imide, LiTFSI, LiN(SO₂CF₃)₂, lithium bis(fluorosulfonyl)imide, LiFSI, LiN(SO₂F)₂, LiCF₃SO₃, LiAsF₆, LiSbF₆, LiClO₄, or mixtures thereof.

The lithium salt may include an imide salt, e.g., lithium bis(trifluoro methanesulfonyl)imide (LiTFSI), LiN(SO₂CF₃)₂, lithium bis(fluorosulfonyl)imide, LiFSI, and LiN(SO₂F)₂. The lithium salt may maintain or improve ion conductivity by appropriately maintaining chemical reactivity with the ionic liquid.

The ionic liquid has a melting point below ambient temperature, so it may be a salt or a room-temperature molten salt in a liquid state at ambient temperature and composed of ions.

The ionic liquid may be a compound including at least one cation, e.g., ammonium, pyrrolidinium, pyridinium, pyrimidinium, imidazolium, piperidinium, pyrazolium, oxazolium, pyridazinium, phosphonium, sulfonium, triazolium, or a mixture thereof, and at least one anion, e.g., BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃—, (FSO₂)₂N⁻, (C₂F₅SO₂)₂N⁻, (C₂F₅SO₂)(CF₃SO₂)N⁻, or (CF₃SO₂)₂N⁻.

The ionic liquid may include, e.g., at least one of N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, or 1-ethyl-3-methylimidazolium bis (trifluoromethylsulfonyl)amide.

A weight ratio of the solid electrolyte and the ionic liquid in the solid electrolyte layer may be about 0.1:99.9 to about 90:10, e.g., about 10:90 to about 90:10, about 20:80 to about 90:10, about 30:70 to about 90:10, about 40:60 to about 90:10, or about 50:50 to about 90:10. A solid electrolyte layer within the above ranges may maintain or improve ion conductivity by improving the electrochemical contact area with the electrode. Accordingly, the energy density, discharge capacity, rate capability, etc. of the solid-state battery may be improved.

The solid-state battery may be a unit battery with a structure of positive electrode/solid electrolyte layer/negative electrode, a bi-cell with a structure of positive electrode/solid electrolyte layer/negative electrode/solid electrolyte layer/positive electrode, or a battery repeatedly stacking the unit batteries.

The shape of the solid-state battery may be, e.g., a coin type, a button type, a sheet type, a stack type, a cylindrical shape, a flat type, and the like. The solid-state battery may be applied to a large-sized battery used in an electric vehicle or the like. In an implementation, the solid-state battery may also be used in a hybrid vehicle such as a plug-in hybrid electric vehicle (PHEV). It may be used in a field requiring a large amount of power storage, and may be used, e.g., to electric bicycles or power tools.

An embodiment represents a solid-state rechargeable battery using a sulfide solid electrolyte. The solid electrolytes may not be used while exposed to the atmosphere due to their nature so they need to be blocked from the atmosphere. To this end, it may be manufactured by inserting a solid-state rechargeable battery into an exterior body using a laminate film or a rigid material.

However, the negative electrode, the solid electrolyte layer, the positive electrode, and the elastic sheet may be stacked on the laminate film and an alignment of the stacked elastic sheets may be misaligned during the vacuum process or during a sealing process. Due to the presence of bubbles during lamination, it may be difficult to provide uniform pressures to the negative electrode/solid electrolyte layer/positive electrode.

If the solid-state rechargeable battery is not uniformly pressurized from the outside while discharging the solid-state rechargeable battery, a movement rate of the lithium ions may be deteriorated, which may lower discharge efficiency, and if it is pressurized locally, the lithium ions may move to the pressurized area, lowering the discharge efficiency.

In an implementation, coulomb efficiency may be increased if the thickness of the negative electrode changes due to charge and discharge. To this end, an embodiment may be configured to help remove air bubbles among the negative electrode, the solid electrolyte layer, the laminate of the positive electrode, and the elastic sheet. The embodiment may be also configured to help remove the air bubbles between the unit cells if stacking the unit cells.

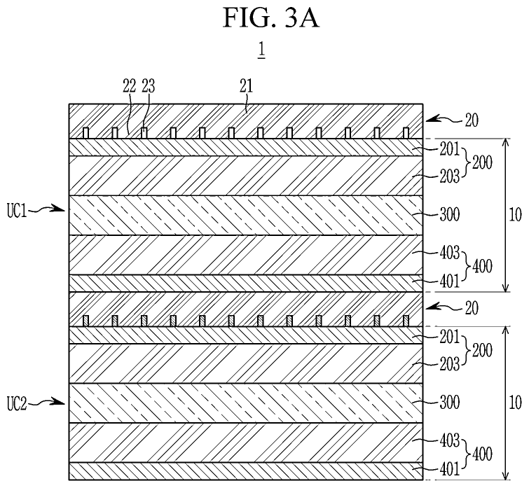

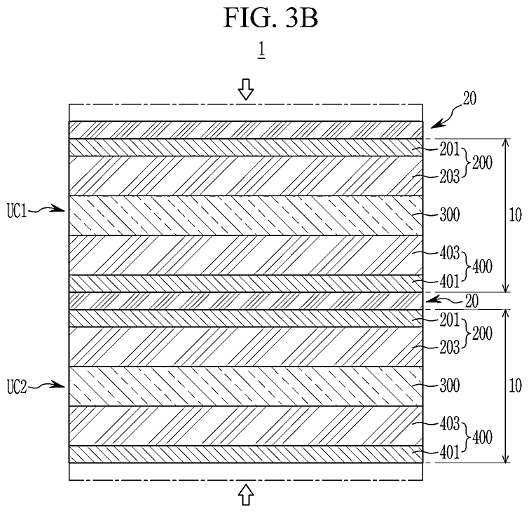

FIG. 3A shows a cross-sectional view before pressurizing a solid-state rechargeable battery according to a first embodiment of the present disclosure, and FIG. 3B shows a cross-sectional view after pressurizing a solid-state rechargeable battery according to a first embodiment of the present disclosure.

Referring to FIG. 3A and FIG. 3B, the solid-state rechargeable battery 1 according to a first embodiment may include a laminate 10 and an elastic sheet 20. The laminate 10 may be formed by stacking the negative electrode 400, the solid electrolyte layer 300, and the positive electrode 200 stacked on one another, and may be referred to as a unit cell. For example, the laminate 10 may include the negative electrode 400, the solid electrolyte layer 300, and the positive electrode 200 stacked on one another. The solid-state rechargeable battery 1 of FIG. 3A and FIG. 3B may each include two unit cells, e.g., a first unit cell UC1 and a second unit cell UC2.

The elastic sheet 20 may be stacked on an outermost portion of the laminate 10 to buffer a volume change of the laminate 10 at the time of charge and discharge, and may have a structure of protrusions and depressions (e.g., grooves). In an implementation, the elastic sheet 20 may have a compressive strength of about 1 MPa to about 7 MPa.

The structure of protrusions and depressions of the elastic sheet 20 may prevent the generation of air bubbles if the negative electrode 400, the solid electrolyte layer 300, the positive electrode 200, and the elastic sheet 20 are stacked on the laminate film so the alignment of the elastic sheet 20 may be prevented from being distorted on the laminate 10 in a vacuum process for sealing the laminate film to be in a vacuous state. Accurate alignment of the laminate 10 and the elastic sheet 20 may enable uniform pressurization of the negative electrode 400, the solid electrolyte layer 300, and the positive electrode 200.

In an implementation, the elastic sheet 20 may be manufactured by mixing about 45 parts of acrylic acid 2-hexylacrylate (2-HEA), about 35 parts of 2-hydroxyethyl acrylate (2-HEA), and about 20 parts of isobornyl acrylate as resin components in a reactor, mixing about 0.5 parts by weight of Irgacure 651 as a photoinitiator, about 0.3 parts by weight of 1,6-hexanediol diacrylate (HDDA) as a crosslinker, about 5 parts by weight of glass bubbles S22, and about 10 parts by weight of extinguishing capsules in size of 50 μm with acrylate mixed resin with reference to 100 parts by weight of the mixture, coating the mixture between a PET film having a lattice-shaped release film, curing the same for five minutes by using ultraviolet rays (UV) to produce a sheet, drying the sheet at about 150° C. for five minutes, and allowing the sheet to have the thickness of about 200 μm.

The elastic sheet 20 may be stacked on at least one side of the outer surface of the negative electrode 400 or the positive electrode 200. For example, the elastic sheet may be stacked on an outer surface of the negative electrode 400 or the positive electrode. In an implementation, the solid-state rechargeable battery may be composed of one laminate 10 and the elastic sheet 20 may be on the negative electrode current collector 401 of the negative electrode 400 and the positive electrode current collector 201 of the positive electrode 200, e.g., on the outer surfaces of both sides of the laminate 10.

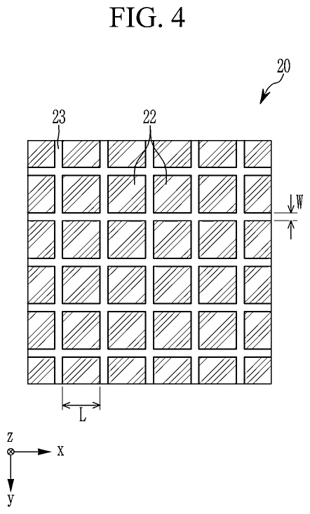

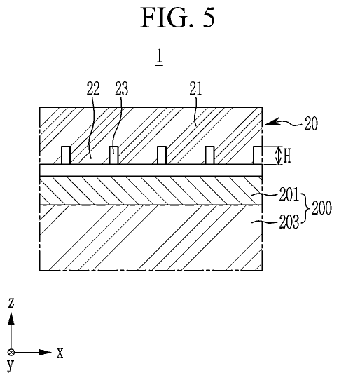

FIG. 4 shows a bottom view on an elastic sheet applied to FIG. 3A and FIG. 3B, and FIG. 5 shows an enlarged cross-sectional view on a portion of an elastic sheet applied to FIG. 3A and FIG. 3B. Referring to FIG. 3A, FIG. 3B, FIG. 4, and FIG. 5, the elastic sheet 20 may include a base portion 21, protrusions 22 protruding from the base portion 21, and a groove 23 between the adjacent protrusions 22 and in the base portion 21.

In an implementation the solid-state rechargeable battery may be configured with one laminate 10 and the protrusions 22 and the groove 23 of the elastic sheet 20 may be in contact with the negative electrode current collector 401 of the negative electrode 400 and the positive electrode current collector 201 of the positive electrode 200, respectively.

Before pressurization, the protrusions 22 and the groove 23 may form an air passage between the negative and positive electrode current collectors 401 and 201. Therefore, if placing the elastic sheet 20 on the laminate 10, misalignment of the elastic sheet 20 may be prevented.

The groove 23 may form a lattice structure with respect to the plane (xy plane) of the base portion 21 (see FIG. 4). The groove 23 may have a rectangular shape structure in the cross-section (xz or yz cross-section) of the base portion 21 before pressurization (see FIG. 5).

The planar lattice structure and the cross-sectional rectangular shape structure may form a uniform air passage over the entire area of the base portion 21 during pressurization and may enable a uniform air flow in the x-axis and y-axis directions. Therefore, misalignment may be prevented in the entire area (xy plane) of the elastic sheet 20 for the laminate 10. If the laminate 10 and the elastic sheet 20 are stacked, a bubble layer may be prevented between them, thereby enabling uniform pressurization of the negative electrode/solid electrolyte layer/negative electrode.

In an implementation, the groove 23 may form a square or rectangular lattice structure with a length (L) of each side of about 0.5 mm to about 1.5 mm in the first direction (x-axis direction) and the second direction (y-axis direction) intersecting each other. For example, each side of respective squares or rectangles of the square or rectangular lattice structure may have a length of about 0.5 mm to about 1.5 mm and may extend in either a first direction or a second direction intersecting with the first direction. The width (W) of the groove 23 may be about 3 μm to about 20 μm, and the height (H) of the groove 23 may be about 2 μm to about 6 μm.

If the side length (L) is less than 0.5 mm, a contact area with the laminate 10 may become too small, so the performance as an elastic layer and a buffer layer of the elastic sheet 20 may be deteriorated, and if it exceeds about 1.5 mm, the number and the area of the grooves 23 become too large, deteriorating the area of the air passage and deteriorating the effect of preventing distortion of the alignment.

If the width (W) of the groove 23 is less than about 3 μm, the area of the air passage may be deteriorated and the effect of preventing distortion of alignment may be deteriorated, and if it is greater than about 20 μm, the performance as an elastic layer and a buffer layer of the elastic sheet 20 may be deteriorated. If the height (H) of the groove 23 is less than about 2 μm, the area of the air passage may be deteriorated, so the effect of preventing distortion of alignment may be deteriorated, and if it is greater than about 6 m, the performance as an elastic layer and a buffer layer of the elastic sheet 20 may be deteriorated.

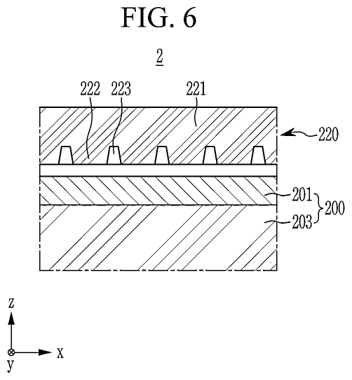

FIG. 6 shows an enlarged cross-sectional view on a portion of an elastic sheet applied to a solid-state rechargeable battery according to a second embodiment of the present disclosure. Referring to FIG. 6, regarding the solid-state rechargeable battery 2 according to a second embodiment, the groove 223 between the protrusions 222 of the elastic sheet 220 and set in the base portion 221 may have a trapezoidal structure in the cross-section of the base portion 21 before pressurization.

In the second embodiment, the contact area of the protrusions 222 and the groove 223 with the laminate 10 may be set to the minimum by the maximum size of the groove 223 and the minimum size of the protrusions 222 before pressurization so that the effect of preventing distortion of air alignment at the initial stage of pressurization may be obtained.

As pressurization of the protrusions 222 and the groove 223 progresses, as the size of groove 223 gradually decreases, and as the size of the protrusions 222 gradually increases, the contact area of the protrusions 222 with the laminate 10 may gradually increases, thereby ensuring the performance of the elastic sheet 220 as an elastic layer and a buffer layer.

That is, if the protrusions 222 and the groove 223 are stacked on the laminate 10 and the elastic sheet 220 according to the second embodiment, the bubble layers may be prevented therebetween, thereby allowing uniform pressurization on the negative electrode/solid electrolyte layer/negative electrode.

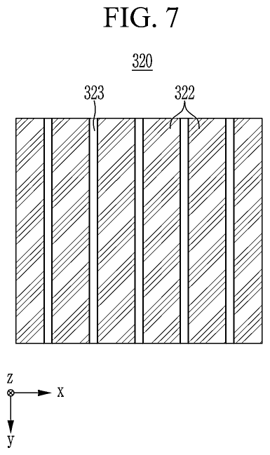

FIG. 7 shows a bottom view on an elastic sheet applied to a solid-state rechargeable battery according to a third embodiment of the present disclosure. Referring to FIG. 5 and FIG. 7, regarding the elastic sheet 320 of the solid-state rechargeable battery according to the third embodiment, the groove 323 between the protrusions 322 and set in the base portion 21 may form a stripe structure with respect to the plane of the base portion 21.

The flat stripe structure and the cross-sectional rectangular structure may form a uniform air passage over the entire area of the base portion 21 if pressurized and may enable a uniform air flow in the y-axis direction. Therefore, misalignment may be prevented in the entire area (xy plane) of the elastic sheet 320 for the laminate 10.

That is, according to the third embodiment, if the laminate 10 and the elastic sheet 320 are stacked, a bubble layer may be prevented between them, thereby enabling uniform pressurization on the negative electrode/solid electrolyte layer/negative electrode. The flat stripe structure according to the third embodiment may have a larger contact area with the laminate 10 than the flat lattice structure according to the first embodiment, so it may further secure the performance of the elastic layer and the buffer layer of the elastic sheet 320.

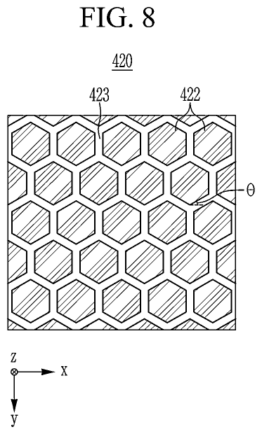

FIG. 8 shows a bottom view on an elastic sheet applied to a solid-state rechargeable battery according to a fourth embodiment of the present disclosure. Referring to FIG. 5 and FIG. 8, regarding the elastic sheet 420 of the solid-state rechargeable battery according to the fourth embodiment, the groove 423 between the protrusions 422 and set to the base portion 21 may form a honeycomb structure with respect to the plane of the base portion 21.

That is, the honeycomb structure may, if forming at least one protrusion 422, be formed by configuring the groove 423 on an external side forming the protrusion 422 as one hexagonal shape, and periodically arranging the hexagon protrusion 422 and the hexagonal groove 423 over the entire area (xy plane).

The flat honeycomb structure and the cross-sectional rectangular structure may form a uniform air passage over the entire area of the base portion 21 if pressurized, and may allow a uniform air flow in a direction inclined at an angle (0) to the x-axis and in the y-axis direction. Therefore, misalignment may be prevented in the entire area (xy plane) of the elastic sheet 420 for the laminate 10.

That is, if the laminate 10 and the elastic sheet 420 are stacked according to the fourth embodiment, the bubble layer may be prevented between them, thereby enabling uniform pressurization on the negative electrode/solid electrolyte layer/negative electrode. The flat honeycomb structure according to the fourth embodiment may have a smaller contact area with the laminate 10 than the flat lattice structure according to the first embodiment, so the performance of the elastic sheet 420 as an elastic layer and a buffer layer may be secured less.

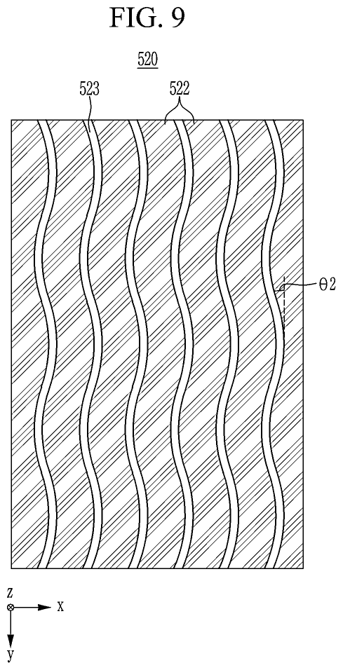

FIG. 9 shows a bottom view on an elastic sheet applied to a solid-state rechargeable battery according to a fifth embodiment of the present disclosure. Referring to FIG. 5 and FIG. 9, regarding the elastic sheet 520 of the solid-state rechargeable battery of the fifth embodiment, the groove 523 between the protrusions 522 and set in the base portion 21 may form a wave structure with respect to the plane of the base portion 21.

That is, the wave structure may be formed, if forming at least one protrusion 522, by configuring the external groove 523 forming the protrusion 522 in a repeated shape of a sinuous curved line in the repeated shape of the sinuous curved lines on both sides, and periodically arranging the protrusion 522 in a repeated shape of a sinuous curved line and the groove 523 in a repeated shape of a sinuous curved line over the entire area (xy plane).

The flat wave structure and the cross-sectional rectangular structure may form a uniform air passage over the entire area of the base portion 21 if pressurized, and may allow a uniform air flow finally in the y-axis direction via a direction inclined at an angle θ2 to the y-axis. Therefore, the misalignment may be prevented in the entire area (xy plane) of the elastic sheet 520 for the laminate 10.

That is, if the laminate 10 and the elastic sheet 520 are stacked according to the fifth embodiment, a bubble layer may be prevented between them, thereby enabling a uniform pressurization on the negative electrode/solid electrolyte layer/negative electrode. The flat wave structure according to the fifth embodiment may have a larger contact area to the laminate 10 than the flat stripe structure according to the second embodiment, so it may further secure the performance of the elastic layer and the buffer layer of the elastic sheet 520.

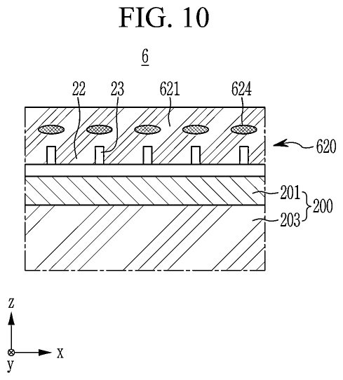

FIG. 10 shows an enlarged cross-section view of a portion of an elastic sheet applied to a solid-state rechargeable battery according to a sixth embodiment of the present disclosure. Referring to FIG. 10, the elastic sheet 620 of the solid-state rechargeable battery 6 of the sixth embodiment, the base portion 621 may contain an extinguishing capsule 624. The elastic sheet 620 with the fire extinguishing capsule 624 may be on at least one side of an outermost portion of the solid-state rechargeable battery 6 and may have a compressive strength of about 1 MPa to about 7 MPa.

In an implementation, the elastic sheet 620 may be compressed because of an increase of the pressure above a predetermined level, the fire extinguishing capsule 624 may be operated to extinguish an ignition of the solid-state rechargeable battery 6 at an early stage and may prevent diffusion of the ignition.

Referring to FIGS. 3A, 3B, and 4, the elastic sheet 20 may have a structure of protrusions and depressions and may be stacked between the first unit cell UC1 and the second unit cell UC2 and on the outermost portion of the first unit cell UC1 or the second unit cell UC2 to buffer the volume changes of the first unit cell UC1 and the second unit cell UC2 during charge and discharge.

The base portion 21 of the elastic sheet 20 may contact the negative electrode current collector 401 of the negative electrode 400 of the first unit cell UC1, and the protrusions 22 and the groove 23 may contact the positive electrode current collector 201 of the positive electrode 200 of the second unit cell UC2.

The flat lattice structure and the cross-sectional rectangular structure may form a uniform air passage over the entire area of the base portion 21 between the first unit cell UC1 and the second unit cell UC2 during pressurization, and may provide a uniform air flow in the x and y-axis directions.

Therefore, misalignment may be prevented in the entire area (xy plane) of the elastic sheet 20 for the first unit cell UC1 and the second unit cell UC2. In an implementation, the first unit cell UC1, the elastic sheet 20, and the second unit cell UC2 may be stacked and a bubble layer may be prevented between them, enabling uniform pressurization on the negative electrode/solid electrolyte layer/negative electrode.

The flat lattice structure and the cross-section rectangular structure provided on the outermost may form a uniform air passage for the entire area of the base portion 21 during pressurization between the first unit cell UC1 and the structures or between the second unit cell UC2 and the structures, enabling a uniform air flow in the x and y-axis directions.

Therefore, misalignment may be prevented in the entire area (xy plane) of the elastic sheet 20 for the first unit cell UC1 and the entire area (xy plane) of the elastic sheet 20 for the second unit cell UC2. The bubble layer may be prevented therebetween if stacking the first unit cell UC1 and the elastic sheet 20 and therebetween if stacking the second unit cell UC2 and the elastic sheet 20, thereby enabling uniform pressurization on the negative electrode/solid electrolyte layer/negative electrode.

Referring to FIGS. 3A, 3B, 4, and 10, the elastic sheet 620 may be on the outermost portions of the first unit cell UC1 and the second unit cell UC2 and may have a fire extinguishing capsule 624 built into the base portion 621. If the elastic sheet 620 is compressed because of an increase of the pressure above a predetermined level, the fire extinguishing capsule 624 may be operated to initially extinguish the ignition of the solid-state rechargeable battery 1 and may prevent the diffusion of ignition.

By way of summation and review, lithium ion batteries may use an electrolyte solution containing a flammable organic solvent, so there may be a possibility of overheating and fire if a short circuit occurs. In response to this, a solid-state rechargeable battery using a solid electrolyte instead of an electrolyte solution is being proposed.

By not using flammable organic solvents, the solid-state rechargeable batteries may greatly reduce the possibility of fire or explosion even when the short circuit occurs. Therefore, the solid-state batteries may greatly increase safety compared to the lithium ion batteries using electrolyte solutions.

One or more embodiments may provide a solid-state rechargeable battery for removing generation of bubbles among a negative electrode, a solid electrolyte layer, a laminate of a positive electrode, and an elastic sheet.

One or more embodiments may provide a solid-state rechargeable battery for removing generation of bubbles among unit cells when stacking the unit cells.

One or more embodiments may provide an elastic sheet having the structure of protrusions and depressions on the laminate of the negative electrode and the solid electrolyte layer, and the positive electrode may be stacked such that there are no bubbles between the laminate and the elastic sheet in the vacuum process if sealing the laminate, thereby enabling accurate alignment. Uniform pressure may thereby be provided to the negative electrode/solid electrolyte layer/positive electrode.

In one or more embodiments an accurate alignment may be performed if stacking the first unit cell and the second unit cell as there are no bubbles between the first unit cell and the second unit cell by the elastic sheet having the structure of protrusions and depressions on the laminate. Thereby, uniform pressure may be provided to the first unit cell and the second unit cell.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A solid-state rechargeable battery comprising:
a laminate including a negative electrode, a solid electrolyte layer, and a positive electrode stacked on one another; and
an elastic sheet including a structure of protrusions and depressions stacked on an outermost portion of the laminate and buffering changes of a volume of the laminate during charge and discharge.

2. The solid-state rechargeable battery as claimed in claim 1, wherein the elastic sheet is stacked on an outer surface of the negative electrode or the positive electrode.

3. The solid-state rechargeable battery as claimed in claim 1, wherein the elastic sheet includes:
a base portion,
protrusions protruding from the base portion, and
a groove between adjacent protrusions and in the base portion.

4. The solid-state rechargeable battery as claimed in claim 3, wherein the groove forms a lattice structure on a plane of the base portion.

5. The solid-state rechargeable battery as claimed in claim 4, wherein:
the lattice structure is a square or rectangular lattice structure, and
each side of respective squares or rectangles of the square or rectangular lattice structure has a length of about 0.5 mm to about 1.5 mm and extends in either a first direction or a second direction intersecting with the first direction.

6. The solid-state rechargeable battery as claimed in claim 5, wherein:
a width of the groove is about 3 μm to about 20 μm, and
a height of the groove is about 2 μm to about 6 μm.

7. The solid-state rechargeable battery as claimed in claim 6, wherein the groove has a rectangular structure in a cross-section of the base portion.

8. The solid-state rechargeable battery as claimed in claim 6, wherein the groove has a trapezoidal structure in a cross-section of the base portion.

9. The solid-state rechargeable battery as claimed in claim 3, wherein the groove forms a stripe structure on a plane of the base portion.

10. The solid-state rechargeable battery as claimed in claim 3, wherein the groove forms a honeycomb structure on a plane of the base portion.

11. The solid-state rechargeable battery as claimed in claim 3, wherein the groove forms a wave structure on a plane of the base portion.

12. The solid-state rechargeable battery as claimed in claim 3, wherein the base portion includes an extinguishing capsule.

13. A solid-state rechargeable battery comprising:
a first unit cell and a second unit cell each unit cell including a negative electrode, a solid electrolyte layer, and a positive electrode stacked on one another; and
an elastic sheet with a structure of protrusions and depressions stacked between the first unit cell and the second unit cell and on an outermost portion of the first unit cell or the second unit cell and buffering changes of volumes of the first unit cell and the second unit cell during charge and discharge.

14. The solid-state rechargeable battery as claimed in claim 13, wherein the elastic sheet includes:
a base portion,
protrusions protruding from the base portion, and
a groove between adjacent protrusions and in the base portion.

15. The solid-state rechargeable battery as claimed in claim 14, wherein:
the base portion contacts a negative electrode of the first unit cell, and
the protrusions and the groove contact a positive electrode of the second unit cell.

16. The solid-state rechargeable battery as claimed in claim 14, wherein the elastic sheet on the outermost portion of the first unit cell or the second unit cell includes an extinguishing capsule in the base portion.
